(19) United States
(12) Patent Application Publication
(10) Pub. No.: US 2002/0121077 A1
(43) Pub. Date: Sep. 5, 2002

(54) Filter medium, filter and apparatus for supplying air or chemical equipped with the same

(76) Inventors: Tae-Ho Kim, Seoul (KR); Jung-Sung Hwang, Suwon-si (KR); Hyun-Cheon Jang, Seongnam-si (KR); Soon-Young Lee, Seoul (KR)

Correspondence Address: VOLENTINE FRANCOS, P.L.L.C., Suite 150, 12200 Sunrise Valley Drive, Reston, VA, 20191, US

(21) Appl. No.: 10/035,200

(22) Filed: Jan. 4, 2002

(30) Foreign Application Priority Data
Jan. 6, 2001 (KR) 2001-821

(51) Int. Cl. B01D 46/52

(52) U.S. Cl. 55/385.1; 55/495; 55/521

(57) ABSTRACT

A filter medium, a filter into which the filter medium is installed, and an apparatus for supplying air and chemicals equipped with the filter. The filter medium has a sheet including a first pleated portion, which is folded in a first wave shape such that a first amplitude and a first wave length are formed in the first pleated portion. The filter medium also includes a second pleated portion, which is folded in a second wave shape such that a second amplitude, less than the first amplitude, and a second wave length, shorter than the first wave length, are formed in the second pleated portion. At least one second pleated portion is formed in the first pleated portion.

### BACKGROUND OF THE INVENTION

1. Field of the Invention

The present invention relates to a filter medium, a filter into which the filter medium is installed, and an apparatus for supplying air or chemical equipped with the filter, and more particularly, to a filter medium made of a sheet including pleated portions having superior filtering characteristics.

2. Description of the Related Art

The elements of a semiconductor device are becoming more densely integrated to improve the processing speed and increase the memory capacity. Manufacturing processes for 16M and 64M dynamic random access memory (DRAM) devices are being replaced by 256M manufacturing processes, and mass production techniques for 1G devices are rapidly evolving. However, with increases in processing speed, memory capacity, and integration density, the manufacturing techniques to produce the devices must keep pace and become increasingly sophisticated to ensure the production of proper functioning and reliable devices.

A significant amount of failures in semiconductor devices can be attributed to the presence of contaminating particles during the manufacturing process. As the pattern sizes decrease, finer and finer particles must be eliminated from the manufacturing process. As a result, more and more studies are conducted to determine and document the influence of organic or inorganic particles on the semiconductor device during the manufacturing process.

In order to control the particles in the semiconductor manufacturing process, clean rooms utilizing highly-filtered environments are used. There are different classes of clean rooms that are used, depending on the type of device being manufactured and the size of the particles that must be filtered out. For example, the 256M DRAM has a design rule of 0.25 μm. Accordingly, when the 256M DRAM is manufactured, particles having a size greater than 0.25 μm are filtered out.

The particles exist in many areas of the clean room, including the water, chemicals and gases used for manufacturing the semiconductor device, and the clean room ambient atmosphere as well. Accordingly, to produce reliable and properly functioning devices, clean air, in which the particles having a size above the clean room class are removed, must be supplied into the clean room. In addition, particles present in the water, chemicals and gases used to manufacture the semiconductor devices must be supplied into the clean room after the particles are removed.

The particles contained in the air or the device manufacturing materials are mainly removed by using a filter, which is typically installed in air supplying device or other supply device. For example, the particles contained in the ambient air are first removed by a filter so that the clean air is supplied into the semiconductor manufacturing apparatus. Likewise, a chemical supplying device including the filter is installed in the semiconductor manufacturing apparatus so as to remove the particles contained in the chemicals.

The filter mainly consists of a case of a predetermined size and a filter medium. The filter medium is made of a sheet including a pleated portion which is folded in such a manner so as to create a ‘wave shape’ (or undulating shape) having a predetermined amplitude and a predetermined wave length. Accordingly, the filter medium filters the air or chemical passing through the filter medium thereby removing the particles contained in the air or chemical.

The filtering efficiency is proportional to the surface area of the filter medium. When the surface area of the filter medium increases, the velocity of the fluid passing through the filter medium decreases, so that the pressure loss of the fluid caused by the filter medium is lowered. That is, the fluid makes contact with the filter medium for a longer time without increasing the pressure loss, so the filtering efficiency is improved. However, since the case has a predetermined size, it is difficult to increase the surface area of the filter medium.

There are several factors relating to the surface area of the filter medium, such as a length, a width, and a height of the filter medium. Among those factors, the height and width of the filter medium are limited by the height and width of the case, and therefore do not play a role in increasing or extending the surface area of the filter medium within a predetermined case size.

While the length of the filter medium is also limited by the length of the case, the filter medium includes the pleated portion which is folded in a wave shape such that a predetermined amplitude and a predetermined wave length are formed in the pleated portion. Though the amplitude is limited by the height of the case, the wave length is not limited by the height or the length of the filter medium. That is, if the pleated portion is densely formed, the wave length of the filter medium is shortened. Accordingly, the overall length of the filter medium can be increased, thereby expanding the surface area of the filter medium. Therefore, the length of the filter medium closely correlates to the surface area of the filter medium.

Examples of filter media including a pleated portion are disclosed in U.S. Pat. No. 6,045,597 issued to Choi and Korean Patent Laid-Open Publication No. 99-658.

According to the disclosure in the Korean Patent Laid-Open Publication, the pleated portion has a height that is higher in the rear portion than in the front portion for generating an inclined air flow which passes through the filter medium, not for increasing the surface area of the filter medium. Thus, increasing the surface area of the filter medium is limited since using the wave length of the pleated portion is not maximized.

According to the U.S. Pat. No. 6,045,597, an insertion member is inserted into a space formed between folded parts of the pleated portion so as to reduce the pressure loss of the fluid passing through the filter medium. Accordingly, the pleated portion cannot be densely formed due to the insertion member, so the extension of the surface area of the filter medium is limited.

The increase in the surface area of the filter medium depends on the increase in the length of the filter medium. In order to densely form the pleated portion, the length of the filter medium should be increased. However, the pleated portion of the U.S. Pat. No. 6,045,597 has a constant amplitude and a constant wave length. Therefore, the number of folded parts forming the pleated portion is limited by the length of the pleated portion. Accordingly, though the pleated portion is provided in the filter medium, the extension of the surface area of the filter medium is limited, so the filtering efficiency of the filtering medium is restrained.

### SUMMARY OF THE INVENTION

In view of the problems present in the related art, it is a first object of the present invention to provide a filter medium capable of increasing a surface area thereof by increasing a length of the filter medium.

A second object of the present invention is to provide a filter capable of increasing the surface area of the filter medium.

A third object of the present invention is to provide an apparatus for supplying air capable of reducing the pressure loss of the air passing through the filter medium by increasing the surface area of the filter medium.

A fourth object of the present invention is to provided an apparatus for supplying chemicals capable of reducing the pressure loss of a chemical passing through the filter medium by increasing the surface area of the filter medium.

To achieve the first object of the present invention, there is provided a filter medium having a sheet including a first pleated portion and a second pleated portion. The first pleated portion is folded in a first wave shape such that a first amplitude and a first wave length are formed in the first pleated portion. The second pleated portion is folded in a second wave shape such that a second amplitude, less than the first amplitude, and a second wave length, shorter than the first wave length, are formed in the second pleated portion. At least one second pleated portion is formed in the first pleated portion.

The sheet may include first to nₜₕ pleated portions (n is a natural number). The nₜₕ pleated portion has an nₜₕ amplitude less than an (n−1)ₜₕ amplitude of an (n−1)ₜₕ pleated portion, and an nₜₕ wave length shorter than an (n−1)ₜₕ wave length of the (n−1)ₜₕ pleated portion. The second pleated portion is formed along a first slope plane of the first pleated portion and extends in a first longitudinal direction of the first slope plane, and the nₜₕ pleated portion is formed along an (n−1)ₜₕ slope plane of the (n−1)ₜₕ pleated portion and extends in an (n−1)ₜₕ longitudinal direction of the (n−1)ₜₕ slope plane. Accordingly, a great number of pleated portions can be formed in the filter medium. Therefore, the length of the filter medium is continuously increased, so that a surface area of the filter medium can be increased.

To achieve the second object of the present invention, there is provided a filter comprising a case having a predetermined size and a filter medium including a sheet installed in the case. The sheet has a first pleated portion which is folded in a length direction of the case with a first wave shape such that a first amplitude and a first wave length are formed in the first pleated portion, and a second pleated portion which is folded in a second wave shape such that a second amplitude, less than the first amplitude, and a second wave length, shorter than the first wave length, are formed in the second pleated portion. At least one second pleated portion is formed in the first pleated portion.

The sheet includes first to nₜₕ pleated portions (n is a natural number). The nₜₕ pleated portion has an nₜₕ amplitude less than an (n−1)ₜₕ amplitude of an (n−1)ₜₕ pleated portion and an nₜₕ wave length shorter than an (n−1)ₜₕ wave length of the (n−1)ₜₕ pleated portion. The case has a width in a range of about 550 to 650 mm, a length in a range of about 600 to 1300 mm, and a height in a range of about 70 to 300 mm.

The filter includes an air filter for filtering particles contained in air, and in such embodiments the filter medium is comprised of glass fiber. The filter may also include a chemical filter for filtering particles contained in a chemical, and in such embodiments the filter medium is comprised of activated carbon or an ion exchange resin.

Since the length of the filter medium installed in the case having the predetermined size can be increased, the filtering efficiency can be improved.

To achieve the third object of the present invention, there is provided an apparatus for supplying air into a semiconductor manufacturing device. The apparatus comprises an air source for providing the air and a filter installed in the air source for filtering particles contained in the air. The filter has a case with a predetermined size and a filter medium including a sheet installed in the case. The sheet has a first pleated portion which is folded in a length direction of the case with a first wave shape such that a first amplitude and a first wave length are formed in the first pleated portion, and a second pleated portion which is folded in a second wave shape such that a second amplitude, less than the first amplitude, and a second wave length, shorter than the first wave length, are formed in the second pleated portion. At least one second pleated portion is formed in the first pleated portion.

The air source includes an air supplying line connected to the semiconductor manufacturing device and the filter is installed in the air supplying line. The sheet includes first to nₜₕ pleated portions (n is a natural number). The nₜₕ pleated portion has an nₜₕ amplitude less than an (n−1)ₜₕ amplitude of an (n−1)ₜₕ pleated portion and an nₜₕ wave length shorter than an (n−1)ₜₕ wave length of the (n−1)ₜₕ pleated portion.

The filter may comprise an ULPA filter, which filters particles contained in the air having sizes in a range of 0.12 μm to 0.17 μm with an efficiency of 99.99%. In addition, the filter may comprise a HEPA filter, which filters particles contained in the air having a size of 0.3 μm with an efficiency of 99.97%.

Accordingly, since the filter medium capable of extending (or enlarging) the surface area thereof is installed in the air supplying apparatus, particles contained in the air can be effectively removed.

To achieve the fourth object of the present invention, there is provided an apparatus for supplying a chemical into a semiconductor manufacturing device. The apparatus comprises a chemical source for providing the chemical and a filter installed in the chemical source for filtering particles contained in the chemical. The filter has a case with a predetermined size and a filter medium including a sheet installed in the case. The sheet has a first pleated portion which is folded in a length direction of the case with a first wave shape such that a first amplitude and a first wave length are formed in the first pleated portion, and a second pleated portion which is folded in a second wave shape such that a second amplitude, less than the first amplitude, and a second wave length, shorter than the first wave length, are formed in the second pleated portion. At least one second pleated portion is formed in the first pleated portion.

The chemical source includes a chemical supplying line connected to the semiconductor manufacturing device and the filter is installed in the air supplying line. The sheet includes first to nₜₕ pleated portions (n is a natural number). The nₜₕ pleated portion has an nₜₕ amplitude less than an (n−1)ₜₕ amplitude of an (n−1)ₜₕ pleated portion and an nₜₕ wave length shorter than an (n−1)ₜₕ wave length of the (n−1)ₜₕ pleated portion.

Accordingly, since the filter medium capable of extending the surface area thereof is installed in the chemical supplying apparatus, particles contained in the chemical can be effectively removed.

### BRIEF DESCRIPTION OF THE DRAWINGS

The above objects and other advantages of the present invention will become more apparent by describing in detail preferred embodiments thereof with reference to the attached drawings in which:

FIG. 1 is a perspective view showing a filter medium according to one embodiment of the present invention;

FIG. 2 is an enlarged view of a portion “A” in FIG. 1;

FIG. 3 is graph showing the variation of the pressure loss according to the velocity of a fluid passing through the filter medium;

FIG. 4 is a perspective view showing a filter according to one embodiment of the present invention;

FIG. 5 is a schematic view showing an apparatus for supplying air according to one embodiment of the present invention; and

FIG. 6 is a schematic view showing an apparatus for supplying chemical according to one embodiment of the present invention.

### DETAILED DESCRIPTION OF THE PREFERRED EMBODIMENTS

The present invention now will be described more fully with reference to the accompanying drawings, in which preferred embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art.

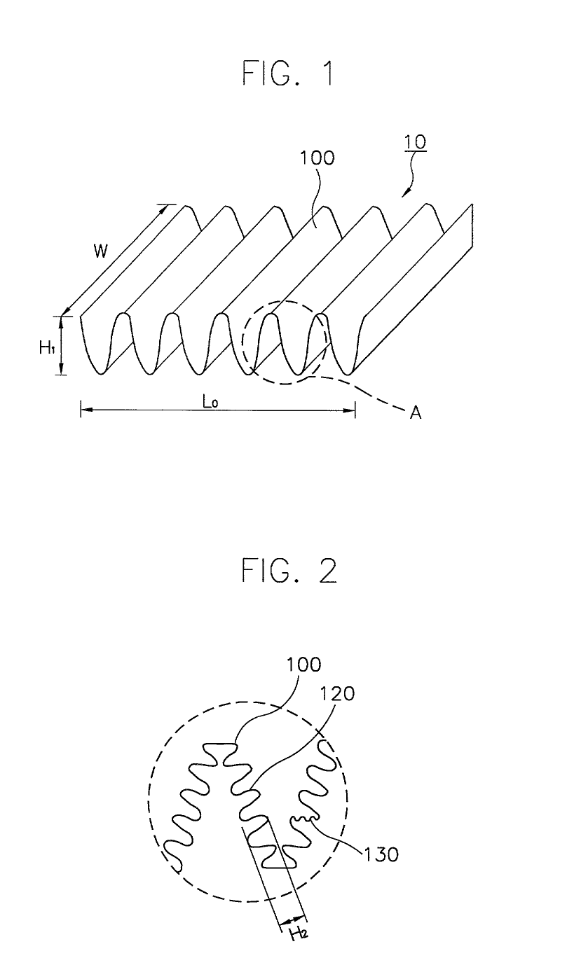

FIG. 1 is a perspective view showing a filter medium according to one embodiment of the present invention. Referring to FIG. 1, the filter medium 10 is provided for filtering particles contained in a fluid passing through the filter medium 10. The filtering efficiency is improved as a surface area of the filter medium 10 becomes larger. Accordingly, in order to increase the surface area of the filter medium 10, pleated portions are formed in the filter medium. The pleated portions include a first pleated portion 100 which is folded along a length direction in a first wave shape (i.e., an undulating shape) such that a first amplitude and a first wave length are formed in the first pleated portion 100.

FIG. 2 is an enlarged view of a portion “A” in FIG. 1. Referring to FIG. 2, the pleated portions include a second pleated portion 120 which is folded in a second wave shape (i.e., an undulating shape) such that a second amplitude, less than the first amplitude, and a second wave length, shorter than the first wave length, are formed in the second pleated portion 120. At least one second pleated portion 120 is formed in the first pleated portion 100.

That is, the pleated portions include the first and second pleated portions 100 and 120 so that the length of the filter medium is enlarged and the surface area of the filter medium 10 is extended. In effect, the second pleated portions 120 form smaller pleated portions on each of the first pleated portions 100.

In addition, the pleated portions may include a third pleated portion 130, which is folded in a third wave shape such that a third amplitude, less than the second amplitude, and a third wave length, shorter than the second wave length, are formed in the third pleated portion 130. At least one third pleated portion 130 is formed in the second pleated portion 120. In effect, the third pleated portions 130 form smaller pleated portions on each of the second pleated portions 120.

In this manner, the filter medium 10 includes first to nₜₕ pleated portions (n is a natural number) wherein, the nₜₕ pleated portion has an nₜₕ amplitude less than an (n−1)ₜₕ amplitude of an (n−1)ₜₕ pleated portion and an nₜₕ wave length shorter than an (n−1)ₜₕ wave length of the (n−1)ₜₕ pleated portion. At least one nₜₕ pleated portion is formed in the (n−1)ₜₕ pleated portion.

As shown in FIG. 2, the second pleated portion 120 is formed along a slope plane of the first pleated portion 100 and extends in a first longitudinal direction of the slope plane. In the same way, the nₜₕ pleated portion is formed along a slope plane of the (n−1)ₜₕ pleated portion and extends in a (n−1)ₜₕ longitudinal direction of the slope plane.

A length L₁ of the filter medium including the first pleated portion 100 is defined by the following equation 1:

L₁=(L₀²+4H₁²n₁²)^{1/2} Equation 1

wherein, L₀ is a horizontal length of the filter medium, H₁ is an amplitude of the first pleated portion, and n₁ is a number of folded parts in the first pleated portion.

The surface area S₁ of the filter medium including the first pleated portion 100 is defined by the following equation 2:

S₁=W×L₁ Equation 2

wherein, W is a width of the filter medium and L₁ is defined as above in Equation 1.

A length L₂ of the filter medium including the first and second pleated portions 100 and 120 is defined by the following equation 3:

L₂=(L₀²+4H₁²n₁²+4H₂²n₂²)^{½} Equation 3

wherein, H₂ is an amplitude of the second pleated portion, n₂ is a number of folded parts in the second pleated portion, and n₁ and L₀ are defined as above with reference to Equation 1.

The surface area S₂ of the filter medium including the first and second pleated portions 100 and 120 is defined by the following equation 4:

S₂=W×L₂ Equation 4

wherein W and L₂ are defined as above.

As noted from the above equations, the length of the filter medium including the first and second pleated portions is increased and the surface area thereof is extended.

In addition, a length Lₙ of the filter medium including the first to nₜₕ pleated portions is defined by the following equation 5.

$${L}_{n} = \sqrt{{L}_{0}^{2} + {\sum }_{i = 1}^{n} 4 {H}_{i}^{2} {n}_{i}^{2}} \qquad Equation 5$$

wherein, Hᵢ is an amplitude of the nₜₕ pleated portion, nᵢ is a number of folded parts in the nₜₕ pleated portion, and L₀ is defined as above.

The surface area Sₙ of the filter medium including the first to nₜₕ pleated portions is defined by the following equation 6:

Sₙ=W×Lₙ Equation 6

wherein, W and Lₙ are defined as above.

As noted from Equations 5 and 6, the length of the filter medium including the first to nₜₕ pleated portions increases and the surface area thereof is extended. That is, as the pleated portion is added, the length of the filter medium is increased more and the surface area of the filter medium is extended more.

If the surface area of the filter medium is extended, the velocity of the fluid, such as air or a chemical, passing through the filter medium decreases since the fluid makes contact with the filter medium for a longer period of time. The fluid may therefore pass through the filter medium without a large pressure loss. In addition, as the surface area of the filter medium increases, the flow rate of the fluid passing through the filter medium can be increased so that the filtering efficiency of the filter medium can be improved.

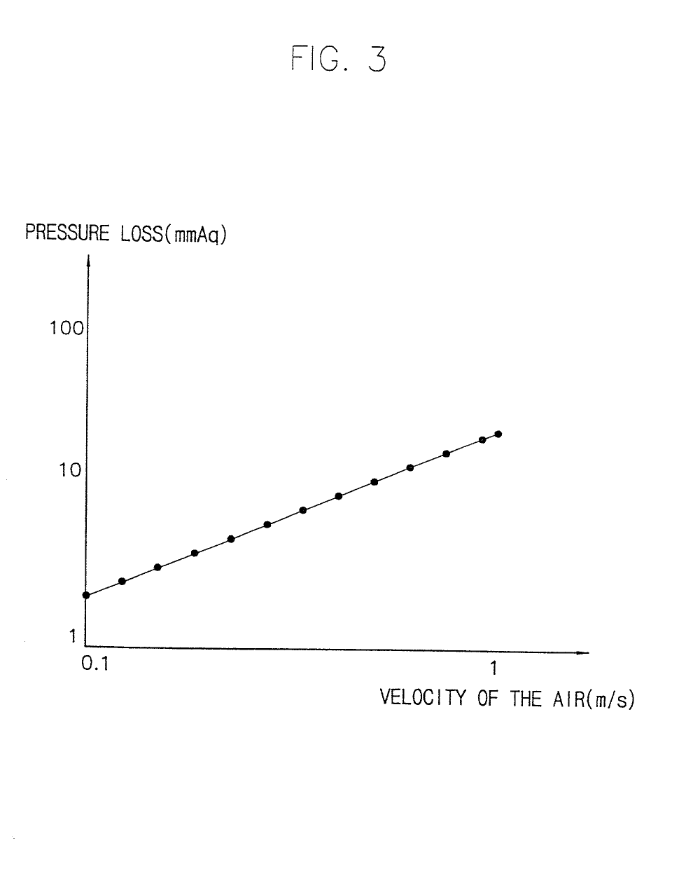

FIG. 3 is a graph showing the variation of the pressure loss according to the velocity of the fluid passing through the filter medium. In this graph, the fluid is air so the variation of the pressure loss as a function of the velocity of the air is represented.

The filter medium is installed, for example, in an ULPA filter for filtering particles contained in the air. Referring to FIG. 3, when the velocity of the air passing through the filter medium is 0.1 m/s, the pressure loss of the air passing through the filter medium is 2 mmAq. By contrast, when the velocity of the air passing through the filter medium is 1 m/s, the pressure loss of the air passing through the filter medium is 20 mmAq. That is, the pressure loss of the air increases as the velocity of the air increases.

As mentioned above, the velocity of the fluid passing through the filter medium is inversely proportional to the surface area of the filter medium. Also, the flow rate of the fluid is proportional to the surface area of the filter medium. Therefore, the velocity of the air decreases while the flow rate of the air increases due to the increase in the surface area of the filter medium, so the pressure loss of the air passing through the filter medium is reduced, thereby improving filtering efficiency.

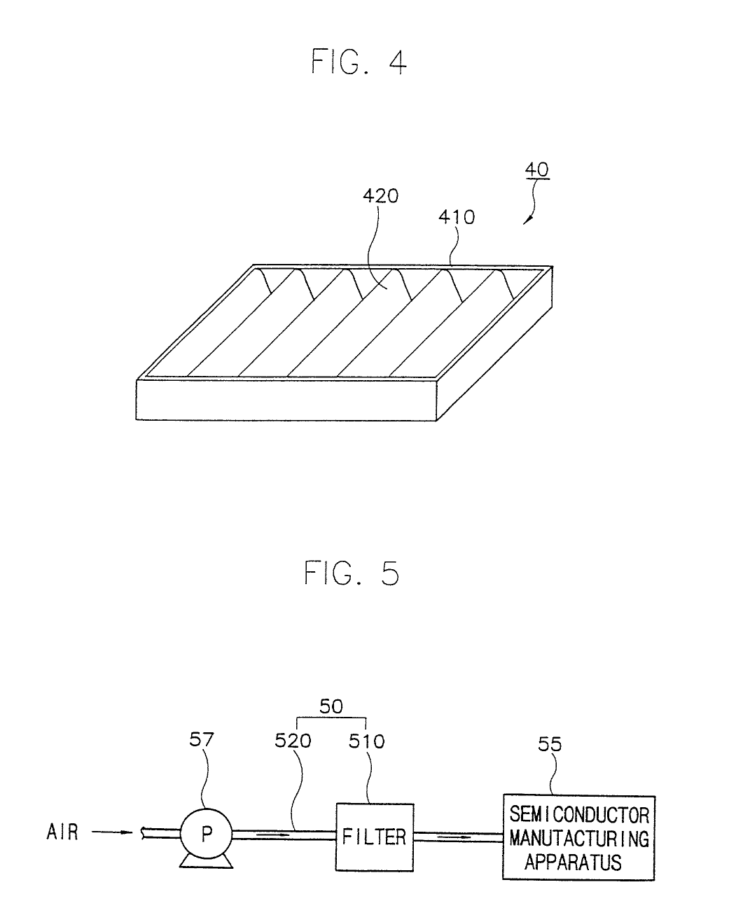

FIG. 4 shows a filter according to one embodiment of the present invention. Referring to FIG. 4, the filter 40 includes a case 410 and a filter medium 420 installed in the case 410.

The case 410 has a predetermined size. Various case sizes can be provided in accordance with the embodiments of the present invention. Exemplary case sizes would include, but are not limited to, the following: a case having a size of 610 mm(width)×762 mm(length)×80 mm(height), a case having a size of 610 mm×915 mm×80 mm, a case having a size of 610 mm×762 mm×150 mm, a case having a size of 610 mm×915 mm×150 mm, a case having a size of 610 mm×762 mm×292 mm, and a case having a size of 610 mm×915 mm×292 mm.

The filter medium 420 has a sheet including a first pleated portion, which is folded in a first wave shape such that a first amplitude and a first wave length are formed in the first pleated portion. The sheet also includes a second pleated portion, which is folded in a second wave shape such that a second amplitude, less than the first amplitude, and a second wave length, shorter than the first wave length, are formed in the second pleated portion. At least one second pleated portion is formed in the first pleated portion.

In addition, the filter medium may include a third pleated portion folded in a third wave shape such that a third amplitude, less than the second amplitude, and a third wave length, shorter than the second wave length, are formed in the third pleated portion. At least one third pleated portion may be formed in the second pleated portion.

In this way, the filter medium includes first to nₜₕ pleated portions wherein, the nₜₕ pleated portion has an nₜₕ amplitude less than a (n−1)ₜₕ amplitude of a (n−1)ₜₕ pleated portion, and an nₜₕ wave length shorter than a (n−1)ₜₕ wave length of the (n−1)ₜₕ pleated portion. At least one nₜₕ pleated portion is formed in the (n−1)ₜₕ pleated portion.

Although the filter medium 420 is installed in the case 410 having a predetermined size, the length of the filter medium 420 can be at least twice as long as the length of the case 410 since the filter medium 420 includes the first to nₜₕ pleated portions. That is, the filter medium 420 having a surface area larger than the effective area of the case 410 can be installed in the case 410. In this way, the surface area of the filter medium 420 can be increased so that the filtering efficiency is improved.

An exemplary relationship between the length of the filter medium and the velocity of the air passing through the filter equipped with the filter medium is as follows.

When the length of the filter medium is 1,200 mm, the velocity of the air is set to 0.4 m/s. If the length of the filter medium is 2,400 mm, the velocity of the air is 0.2 m/s. If the length of the filter medium is 4,800 mm, the velocity of the air is 0.1m/s. Therefore, as the length of the filter medium is increased, the air makes contact with the filter medium for a longer period of time and therefore the pressure loss of the air is lowered so that the filtering efficiency is improved.

Note that in the embodiments described herein and below, while the initial references are to filtering air, it is understood that the wave-like filter medium structure described herein can be equally applied to filter other gases and chemicals within the scope of this invention.

That is, the filter may include an air filter for filtering particles contained in the air, a chemical filter for filtering particles contained in the chemical, or a gas filter for filtering particles contained in the gas. For example, the filter medium installed in the air filter is comprised of glass fiber, while the filter medium installed in the chemical filter may be comprised of activated carbon or an ion exchange resin. In particular, the filter medium installed in the chemical filter may be comprised of a porous sheet.

FIG. 5 shows an apparatus 50 for supplying air according to one embodiment of the present invention. Referring to FIG. 5, the air supplying apparatus 50 is connected to a semiconductor manufacturing apparatus 55 so as to supply the air into the semiconductor manufacturing apparatus 55. The air supplying apparatus 50 filters the particles contained in the air and supplies the clean air into the semiconductor manufacturing apparatus 55.

The air supplying apparatus 50 includes a filter 510 for filtering the air, and an air supplying line 520 connected to the semiconductor manufacturing apparatus 55 so as to supply the air into the semiconductor manufacturing apparatus 55. The filter 510 is installed in the air supplying line 520. The filter 510 includes a case having a predetermined size and a filter medium installed in the case. As described above, the size of the case is variable, and is selected based on the dimensions of the particular apparatus employing the filter.

An air suction device 57 is installed at an inlet of the air supplying line 520 so as to effectively supply the air into the semiconductor manufacturing apparatus 55. The air suction device 57 includes a pump or a fan.

The filter medium installed in the case has first to nₜₕ pleated portions so as to increase the surface area thereof. In detail, the filter medium has a sheet including a first pleated portion, which is folded in the length direction of the case, with a first wave shape such that a first amplitude and a first wave length are formed in the first pleated portion. The filter medium also has a second pleated portion, which is folded in a second wave shape such that a second amplitude, less than the first amplitude, and a second wave length, shorter than the first wave length, are formed in the second pleated portion. At least one second pleated portion is formed in the first pleated portion.

In addition, the filter medium may include a third pleated portion (or more) folded in a third wave shape such that a third amplitude, less than the second amplitude, and a third wave length, shorter than the second wave length, are formed in the third pleated portion. At least one third pleated portion is formed in the second pleated portion.

In this way, the filter medium includes first to nₜₕ pleated portions wherein, the nₜₕ pleated portion has an nₜₕ amplitude less than an (n−1)ₜₕ amplitude of an (n−1)ₜₕ pleated portion and an nₜₕ wave length shorter than an (n−1)ₜₕ wave length of the (n−1)ₜₕ pleated portion. At least one nₜₕ pleated portion is formed in the (n−1)ₜₕ pleated portion.

Accordingly, the surface area of the filter medium installed in the filter is increased. Therefore, the velocity of the air passing through the filter is decreased and the pressure loss of the air is reduced, so that the particles contained in the air can be effectively removed.

The filter medium may be comprised of glass fiber in the case of an air filter. The filter includes an ULPA filter which filters particles contained in the air having sizes in a range of 0.12 μm to 0.17 μm with an efficiency of 99.99%, or a HEPA filter which filters particles contained in the air having a size of 0.3 μm with an efficiency of 99.97%.

By installing the filter 510 having the filter medium capable of increasing the surface area thereof in the air supplying apparatus 50, the failure of the semiconductor device caused by the particles contained in the air can be reduced. In addition, if the air supplying apparatus 50 equipped with the filter 510 is provided in a space for manufacturing the semiconductor device, the clean room class of the space can be efficiently controlled.

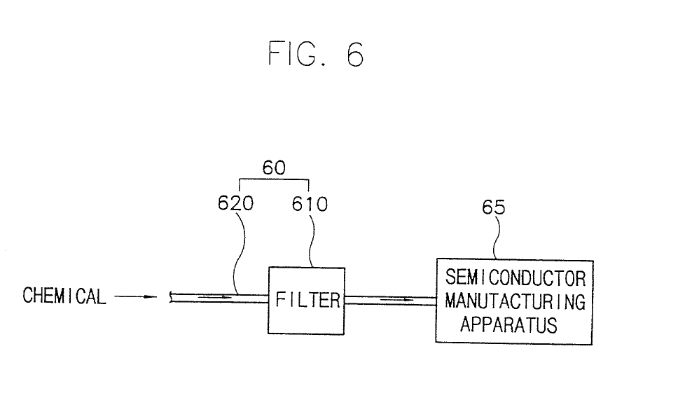

FIG. 6 shows an apparatus 60 for supplying a chemical according to one embodiment of the present invention. Referring to FIG. 6, the chemical supplying apparatus 60 is connected to a semiconductor manufacturing apparatus 65 so as to supply the chemical into the semiconductor manufacturing apparatus 65.

The chemical supplying apparatus 60 filters the particles contained in the chemical and supplies the filtered chemical into the semiconductor manufacturing apparatus 65.

The chemical supplying apparatus 60 includes a filter 610 for filtering the chemical and a chemical supplying line 620 connected to the semiconductor manufacturing device 65 so as to supply the chemical into the semiconductor manufacturing device 65. The filter 610 is installed in the chemical supplying line 620. A pumping member (not shown) for pumping the chemical can be installed at an inlet of the chemical supplying line 620 so as to effectively supply the chemical into the semiconductor manufacturing apparatus 65.

The filter 610 includes a case having a predetermined size and a filter medium installed in the case. As described above, the size of the case is variable, and is selected based on the dimensions of the particular apparatus employing the filter.

The filter medium installed in the case has first to nₜₕ pleated portions so as to increase the surface area thereof. In detail, the filter medium has a sheet including a first pleated portion, which is folded in the length direction of the case, with a first wave shape such that a first amplitude and a first wave length are formed in the first pleated portion. The filter medium also includes a second pleated portion, which is folded in a second wave shape such that a second amplitude, less than the first amplitude, and a second wave length, shorter than the first wave length, are formed in the second pleated portion. At least one second pleated portion is formed in the first pleated portion.

In addition, the filter medium may include a third pleated portion (or more) folded in a third wave shape such that a third amplitude, less than the second amplitude, and a third wave length, shorter than the second wave length, are formed in the third pleated portion. At least one third pleated portion is formed in the second pleated portion.

In this way, the filter medium includes first to nₜₕ pleated portions wherein, the nₜₕ pleated portion has an nₜₕ amplitude less than an (n−1)ₜₕ amplitude of an (n−1)ₜₕ pleated portion and an nₜₕ wave length shorter than a (n−1)ₜₕ wave length of the (n−1)t pleated portion. At least one nₜₕ pleated portion is formed in the (n−1)ₜₕ pleated portion.

Accordingly, the surface area of the filter medium installed in the filter is increased. Therefore, the velocity of the chemical passing through the filter is decreased and the pressure loss of the chemical is reduced, so that the particles contained in the chemical can be effectively removed. The filter medium may be comprised of activated carbon or an ion exchange resin.

By installing the filter 610 having the filter medium capable of increasing the surface area thereof in the chemical supplying apparatus 60, the failure of the semiconductor device caused by the particles contained in the chemical can be reduced.

As described above, according to the present invention, the length of the filter medium can be increased by forming the first to nₜₕ pleated portions in the filter medium. Therefore, the surface area of the filter medium is increased so that the filtering efficiency can be improved when the filtering work is carried out with the filter medium.

Even when the filter medium is installed in a case having a predetermined size, the surface area of the filter medium can be increased by more than the effective area of the case regardless of the size of the case. Accordingly, the filtering efficiency can be improved when the filtering work is carried out with the filter equipped with the filter medium.

If the filter is provided in the air supplying apparatus, the filtering efficiency of the air supplying apparatus is also improved. Therefore, the failure of the semiconductor device caused by the particles contained in the air can be reduced. Accordingly, the reliability of the semiconductor manufacturing process can be improved.

If the filter is provided in the chemical supplying apparatus, the filtering efficiency of the chemical supplying apparatus is also improved. Therefore, the failure of the semiconductor device caused by the particles contained in the chemical can be reduced. Accordingly, the reliability of the semiconductor manufacturing process can be improved.

While the present invention has been described in detail with reference to the preferred embodiments thereof, it should be understood to those skilled in the art that various changes, substitutions and alterations can be made hereto without departing from the scope of the invention as defined by the appended claims.

What is claimed is:

1. A filter medium, comprising:
a sheet including a first pleated portion and a second pleated portion,
wherein the first pleated portion being folded in a first wave shape such that a first amplitude and a first wave length are formed in the first pleated portion,
wherein the second pleated portion being folded in a second wave shape such that a second amplitude, less than the first amplitude, and a second wave length, shorter than the first wave length, are formed in the second pleated portion, and
wherein at least one second pleated portion being formed at the first pleated portion.

2. The filter medium as claimed in claim 1, wherein the sheet includes first to nₜₕ pleated portions, wherein n is a natural number, the nₜₕ pleated portion having an nₜₕ amplitude less than an (n−1)ₜₕ amplitude of an (n−1)ₜₕ pleated portion, and an nₜₕ wave length shorter than an (n−1)ₜₕ wave length of the (n−1)ₜₕ pleated portion.

3. The filter medium as claimed in claim 2, wherein the second pleated portion is formed along a first slope plane of the first pleated portion and extends in a first longitudinal direction of the first slope plane, and the nₜₕ pleated portion is formed along an (n−1)ₜₕ slope plane of the (n−1)ₜₕ pleated portion and extends in an (n−1)ₜₕ longitudinal direction of the (n−1)ₜₕ slope plane.

4. A filter, comprising:
a case having a predetermined size; and
a filter medium including a sheet installed in the case, the sheet being folded in a length direction of the case, and including a first pleated portion and a second pleated portion,
wherein the first pleated portion being folded in a first wave shape such that a first amplitude and a first wave length are formed in the first pleated portion,
wherein the second pleated portion being folded in a second wave shape such that a second amplitude, less than the first amplitude, and a second wave length, shorter than the first wave length, are formed in the second pleated portion, and
wherein at least one second pleated portion being formed at the first pleated portion.

5. The filter as claimed in claim 4, wherein the sheet includes first to nₜₕ pleated portions, wherein n is a natural number, the nₜₕ pleated portion having an nₜₕ amplitude less than an (n−1)ₜₕ amplitude of an (n−1)ₜₕ pleated portion, and an nₜₕ wave length shorter than an (n−1)ₜₕ wave length of the (n−1)ₜₕ pleated portion, and
wherein the second pleated portion being formed along a first slope plane of the first pleated portion and extending in a first longitudinal direction of the first slope plane, and the nₜₕ pleated portion being formed along an (n−1)ₜₕ slope plane of the (n−1)ₜₕ pleated portion and extending in an (n−1)ₜₕ longitudinal direction of the (n−1)ₜₕ slope plane.

6. The filter as claimed in claim 4, wherein the case has a case width in a range of 550 to 650 mm, a case length in a range of 600 to 1300 mm, and a case height in a range of 70 to 300 mm, and a sheet length of the filter medium including the first to nₜₕ pleated portions is greater than twice the case length.

7. The filter as claimed in claim 6, wherein the filter comprises an air filter for filtering particles contained in an air supply, and the filter medium is comprised of glass fiber.

8. The filter as claimed in claim 4, wherein the filter comprises a chemical filter for filtering particles contained in a chemical supply, and the filter medium is comprised of one of activated carbon and an ion exchange resin.

9. The filter as claimed in claim 8, wherein the sheet comprising the filter medium is porous.

10. An apparatus for supplying air into a semiconductor manufacturing device, comprising:
an air source for providing the air; and
a filter installed in a path of the air source for filtering particles contained in the air, the filter having a case with a predetermined size and a filter medium including a sheet installed in the case, the sheet being folded in a length direction of the case and including a first pleated portion and a second pleated portion,
wherein the first pleated portion being folded in a first wave shape such that a first amplitude and a first wave length are formed in the first pleated portion,
wherein the second pleated portion being folded in a second wave shape such that a second amplitude, less than the first amplitude, and a second wave length, shorter than the first wave length, are formed in the second pleated portion, and
wherein at least one second pleated portion being formed at the first pleated portion.

11. The apparatus as claimed in claim 10, wherein the air source includes an air supply line connected to the semiconductor manufacturing device and the filter is installed in the air supply line.

12. The apparatus as claimed in claim 10, wherein the sheet includes first to nₜₕ pleated portions, wherein n is a natural number, the nₜₕ pleated portion having an nₜₕ amplitude less than an (n−1)ₜₕ amplitude of an (n−1)ₜₕ pleated portion and an nₜₕ wave length shorter than an (n−1)ₜₕ wave length of the (n−1)ₜₕ pleated portion, and
wherein the second pleated portion being formed along a first slope plane of the first pleated portion and extending in a first longitudinal direction of the first slope plane, and the nₜₕ pleated portion being formed along an (n−1)ₜₕ slope plane of the (n−1)ₜₕ pleated portion and extending in an (n−1)ₜₕ longitudinal direction of the (n−1)ₜₕ slope plane.

13. The apparatus as claimed in claim 10, wherein the filter includes an ULPA filter which filters particles contained in the air having sizes in a range of 0.12 μm to 0.17 μm with an efficiency of 99.99%.

14. The apparatus as claimed in claim 10, wherein the filter includes a HEPA filter which filters particles contained in the air having a size of 0.3 μm with an efficiency of 99.97%.

15. The apparatus as claimed of claim 10, wherein the filter medium is comprised of glass fiber.

16. An apparatus for supplying a chemical into a semiconductor manufacturing device, comprising:
a chemical source for providing the chemical; and
a filter installed in a path of the chemical source for filtering particles contained in the chemical, the filter having a case with a predetermined size and a filter medium including a sheet installed in the case, the sheet being folded in a length direction of the case and including a first pleated portion and a second pleated portion,
wherein the first pleated portion being folded in a first wave shape such that a first amplitude and a first wave length are formed in the first pleated portion,
wherein the second pleated portion being folded in a second wave shape such that a second amplitude, less than the first amplitude, and a second wave length, shorter than the first wave length, are formed in the second pleated portion, and
wherein at least one second pleated portion being formed at the first pleated portion.

17. The apparatus as claimed in claim 16, wherein the chemical source includes a chemical supply line connected to the semiconductor manufacturing device and the filter is installed in the chemical supply line.

18. The apparatus as claimed in claim 16, wherein the sheet includes first to nₜₕ pleated portions, wherein n is a natural number, the nₜₕ pleated portion having an nₜₕ amplitude less than a (n−1)ₜₕ amplitude of a (n−1)ₜₕ pleated portion and an nₜₕ wave length shorter than a (n−1)ₜₕ wave length of the (n−1)ₜₕ pleated portion.

19. The apparatus as claimed in claim 16, wherein the filter medium is comprised of one of activated carbon and ion exchange resin.

20. The filter as claimed in claim 19, wherein the sheet comprising the filter medium is porous.
